(19) United States
(12) Patent Application Publication
(10) Pub. No.: US 2016/0056676 A1
(43) Pub. Date: Feb. 25, 2016

(54) PARTIALLY SEGMENTED WOUND ROTOR ASSEMBLY FOR HIGH COPPER FILL AND METHOD

(71) Applicant: GM GLOBAL TECHNOLOGY OPERATIONS LLC, Detroit, MI (US)

(72) Inventors: Terence G. Ward, Redondo Beach, CA (US); Constantin C. Stancu, Anaheim, CA (US); Khwaja M. Rahman, Troy, MI (US); Srihari Gangaraj, Troy, MI (US); Brooks S. Mann, Redondo Beach, CA (US)

(21) Appl. No.: 14/467,345

(22) Filed: Aug. 25, 2014

(51) Int. Cl. H02K 1/28; H02K 1/24

(52) U.S. Cl. CPC H02K 1/28; H02K 1/24

(57) ABSTRACT

A partially segmented rotor assembly for an electric motor and a method for the same is provided. The partially segmented rotor assembly includes a first rotor segment and a plurality of second rotor segments. The first rotor segment has a plurality of first poles wound with a wire and defines a first circumferential gap between the wire of each adjacent pair of the first poles. Each second rotor segment has a second pole wound with the wire and is rigidly attached to the first rotor segment in a respective one of the first circumferential gaps to form a plurality of second circumferential gaps between the wire of each first pole and the wire of the adjacent second poles. The first and second rotor segments are configured to cooperate with one another to minimize the second circumferential gaps.

### CROSS-REFERENCES

This invention was made with U.S. Government support under the U.S. Electric Drive Manufacturing Center—Global RWD Electric Contract: DE-EE0002629 awarded by the Department of Energy. The U.S. Government may have certain rights in this invention.

### TECHNICAL FIELD

This disclosure for a vehicle relates to a rotor assembly and method for an electric motor.

### BACKGROUND

Vehicle electric motors typically include rotors with multiple poles. Each rotor pole of a wound or filled rotor is typically wound with copper wire. The electric motor may produce more torque and/or may be more efficient when more copper wire is wound on each rotor pole, i.e. when a higher copper fill factor is achieved. Copper fill factor is the ratio of the area of copper wire wound on each rotor pole over the empty slot area of each rotor pole before the copper wire is wound. Higher copper fill factor may be achieved by winding more turns of copper wire and/or by winding a heavier gauge copper wire on each rotor pole. The number of turns and/or gauge of copper wire that can be wound on each rotor pole are limited by the clearance requirements of wire winding equipment such as needle winders. It is desirable to increase the copper fill factor on each rotor while maintaining motor speed, noise, and vibration performance. It is also desirable to eliminate or reduce the need to use needle winders for winding of wire on the rotor poles.

### SUMMARY

A partially segmented rotor assembly for an electric motor includes a first rotor segment and a plurality of second rotor segments. The first rotor segment has a plurality of first poles wound with a wire and defines a first circumferential gap between the wire of each adjacent pair of the first poles. Each second rotor segment has a second pole wound with the wire and is rigidly attached to the first rotor segment in a respective one of the first circumferential gaps to form a plurality of second circumferential gaps between the wire of each first pole and the wire of the adjacent second poles. The first and second rotor segments are configured to cooperate with one another to minimize the second circumferential gaps.

A vehicle has an electric motor that includes a partially segmented rotor assembly. The partially segmented rotor assembly includes a first rotor segment, a plurality of second rotor segments, and a fastener. The first rotor segment has a plurality of first poles wound with a wire and an attachment feature. The second rotor segments each have a second pole wound with the wire and an attachment feature. The second rotor segment attachment feature, the first rotor segment attachment feature, and the fastener are configured to cooperate with one another such that the second rotor segment is rigidly attached to the first rotor segment.

A method to manufacture a rotor for an electric motor having a plurality of poles includes forming a first rotor segment, having a plurality of first poles, and a plurality of second rotor segments, each having a second pole, winding a wire onto the first poles of the first rotor segment, winding the wire onto the second pole of each of the second rotor segments, and attaching the second rotor segments rigidly to the first rotor segment after winding the wire on all of the poles.

The partially segmented rotor assembly, vehicle, and method enable increased rotor pole copper fill factor while maintaining electric motor speed, noise, and vibration performance. They also eliminate or reduce the need to use needle winding equipment in the rotor manufacturing process.

The above features and advantages and other features and advantages of the present teachings are readily apparent from the following detailed description of the best modes for carrying out the present teachings when taken in connection with the accompanying drawings.

### BRIEF DESCRIPTION OF THE DRAWINGS

FIG. 1 is a schematic illustration of a vehicle having an electric motor that includes a partially segmented rotor assembly;

FIG. 2 is a schematic exploded view illustration of the partially segmented rotor assembly of FIG. 1 showing a first rotor segment, a plurality of second rotor segments, and fasteners, before a wire is wound on the poles of the first and second rotor segments;

FIG. 3 is a schematic exploded view illustration of the partially segmented rotor assembly of FIG. 2 after the wire has been wound on the poles of the first and second rotor segments;

FIG. 4 is a schematic illustration of the partially segmented rotor assembly of FIG. 3 after assembly of the rotor segments with wire wound around each pole;

FIG. 5 is a fragmentary schematic illustration of the segmented rotor assembly of FIG. 2 showing a plurality of laminated sheets or layers and an attachment feature in the first rotor segment;

FIGS. 6A-F are schematic illustrations of alternative embodiments of the fastener for the segmented rotor assembly of FIG. 2;

FIG. 7 is a flow chart of a method to manufacture a multi-pole electric motor; and

FIG. 8 is a schematic illustration of a blank showing how all of the sheets for a layer of the first rotor segment and the plurality of second rotor segments may be cut from the same blank.

### DETAILED DESCRIPTION

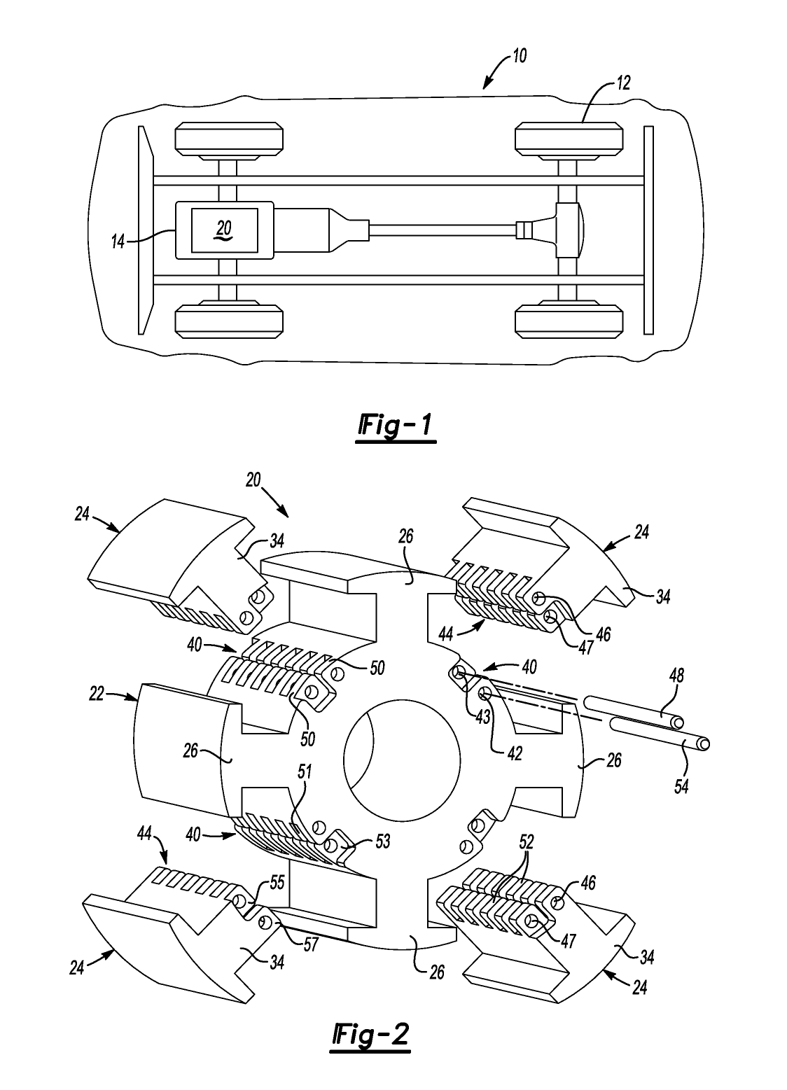

Referring to the drawings, wherein like reference numbers refer to like components throughout the views, FIG. 1 shows a vehicle 10 having wheels 12 and an electric motor 14. The electric motor 14 may be operatively connected to the wheels 12 to provide power for vehicle 10 propulsion. The operative connection may include, but is not limited to, a transmission, a gear set, a universal joint, a driveshaft, and bearings. Alternatively, the electric motor 14 may be used to power other vehicle 10 functions, for example starting an internal combustion engine, powering windshield wipers, powering seat adjusters, powering door locks, powering door opening and closing, and powering window opening and closing. The electric motor 14 may be mounted inside a transmission (not shown), e.g. in a power-split hybrid vehicle. The electric motor 14 includes a partially segmented rotor assembly 20.

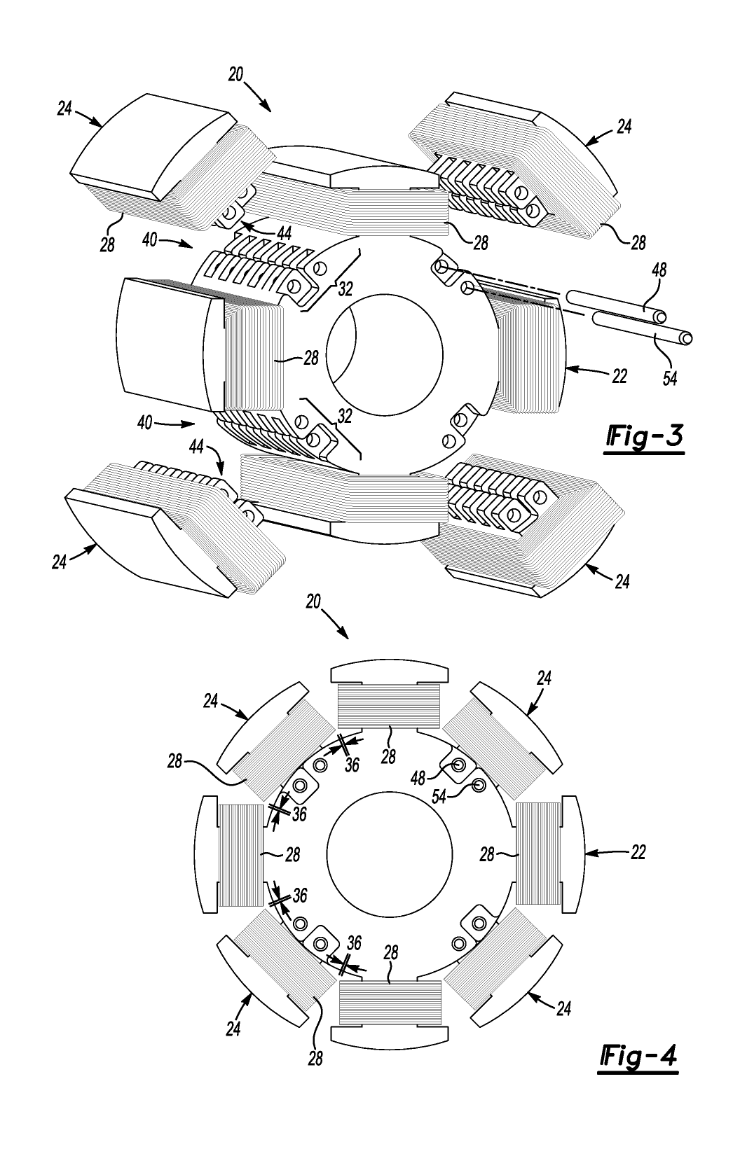

Referring generally to FIGS. 2-4, the partially segmented rotor assembly 20 includes a first rotor segment 22 and a plurality of second rotor segments 24. The first rotor segment 22 has a plurality of first poles 26 wound with a wire 28. The first rotor segment 22 is configured to define a first circumferential gap 32, as best shown if FIG. 3, between the wire 28 of each adjacent pair of the first poles 26. The second rotor segments 24 each have a second pole 34 wound with the wire 28. The second rotor segments 24 are rigidly attached to the first rotor segment 22 in a respective one of the first circumferential gaps 32 to form a plurality of second circumferential gaps 36, as best shown in FIG. 4, between the wire 28 of each first pole 26 and the wire 28 of the adjacent second poles 34. The first and second rotor segments 22, 24 are configured to cooperate with one another to minimize the second circumferential gaps 36. The rotor assembly 20 is partially segmented because some of the poles 26, 34 are included on the first rotor segment 22. If the rotor assembly 20 was fully segmented, all of the poles 26, 34 would be included on the second rotor segments 24 and none of the poles 26, 34 would be included on the first rotor segment 22.

The second circumferential gaps 36 between the wire 28 of each first pole 26 and the wire 28 of the adjacent second poles 34 may be the smallest at the inner base of the poles 26, 34 and may be larger at the outer ends of the poles 26, 34, as shown. Alternatively, the second circumferential gaps 36 between the wire 28 of each first pole 26 and the wire 28 of the adjacent second poles 34 may be uniform from the inner base to the outer ends of the poles 26, 34, or may be any other suitable configuration. Minimizing the second circumferential gap 36 is defined as reducing the second circumferential gap 36 to a gap that is less than the minimum gap that can be achieved with a needle winder when the rotor is not partially segmented. The minimum gap that can be achieved with a needle winder when the rotor is not partially segmented is approximately 5 to 8 mm. This 5 to 8 mm gap is necessitated by the clearance requirements of the needle winder and by the less orderly or less uniform wind that results from winding with a needle winder. The minimized second circumferential gap 36 may be approximately 1 to 4 mm. Alternatively, the minimized second circumferential gap 36 may be approximately 1 mm.

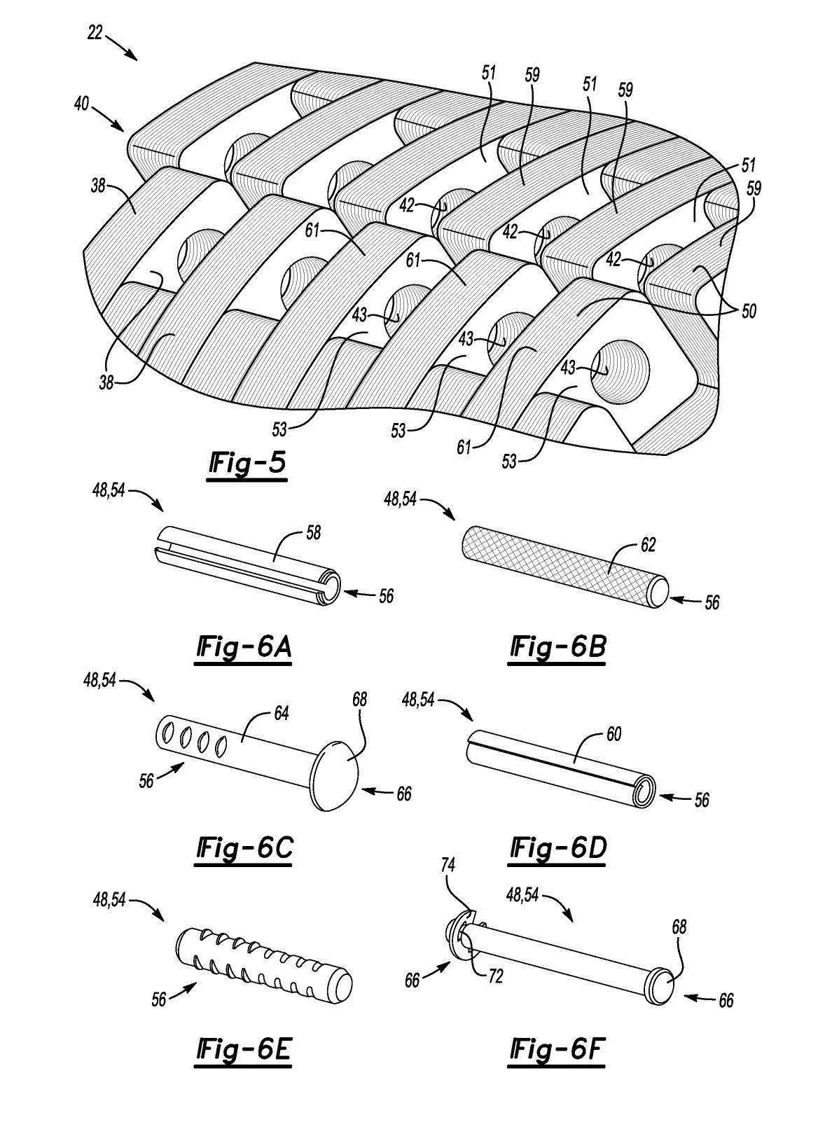

The first and second rotor segments 22, 24 may be made of respective laminated sheets or layers 38, as best seen in FIG. 5. The laminated sheets or layers 38 may be made of a magnetic material. The laminated sheets or layers 38 may be attached to one another by an adhesive bond, by an interlock or mechanical clinch, by a fastener, or by any other suitable attachment method. The wire 28 may be made of an electrically conductive material. The conductive material may be copper or may be any other suitable metal or a non-metal.

Returning to FIGS. 2-4, the first rotor segment 22 may have an attachment feature 40 including a hole 42, 43 formed in the first rotor segment 22. Each second rotor segment 24 may have an attachment feature 44 including a hole 46, 47 formed in the second rotor segment 24.

The partially segmented rotor assembly 20 may include a fastener 48 disposed in at least the respective holes 43, 46 formed in the attachment features 40, 44 of the first and second rotor segments 22, 24 such that the first rotor segment 22 and the second rotor segments 24 are rigidly and permanently attached to each other. The partially segmented rotor assembly 20 may include a fastener 54 disposed in at least the respective holes 42, 47 formed in the attachment features 40, 44 of the first and second rotor segments 22, 24 such that the first rotor segment 22 and the second rotor segments 24 are rigidly and permanently attached to each other.

The fastener 48, 54 may be a cylindrical pin, as shown in FIGS. 2-4, or may be any other suitable fastener alternative, as will be described in greater detail below, with reference to FIGS. 6A-F. The fastener, such as 48, 54, may be riveted or swaged after installation. The fastener 48, 54 may be made of a magnetic material.

Referring again to FIG. 2, the fastener 48, the hole 43 formed in the attachment feature 40 of the first rotor segment 22, and the hole 46 formed in the attachment feature 44 of the second rotor segments 24 may be configured such that the fastener 48 is in an interference fit relationship with at least one of the holes 43, 46 formed in the attachment features 40, 44 of the first and second rotor segments 22, 24 such that the first rotor segment 22 and the second rotor segments 24 are rigidly and permanently attached to each other. The fastener 54, the hole 42 formed in the attachment feature 40 of the first rotor segment 22, and the hole 47 formed in the attachment feature 44 of the second rotor segments 24 may be configured such that the fastener 54 is in an interference fit relationship with at least one of the holes 42, 47 formed in the attachment features 40, 44 of the first and second rotor segments 22, 24 such that the first rotor segment 22 and the second rotor segments 24 are rigidly and permanently attached to each other.

The second rotor segment attachment feature 44 may include an interlocking feature 52 and the first rotor segment attachment feature 40 may include an interlocking feature 50. The second rotor segment interlocking feature 52 and the first rotor segment interlocking feature 50 may cooperate with one another such that the first rotor segment 22 and the second rotor segments 24 are rigidly and permanently attached to each other. For example, the second rotor segment interlocking feature 52 may include tabs 55, 57. The first rotor segment 22 may be configured to form slots 51, 53 in the first rotor segment interlocking feature 50. The tabs 55, 57 may be configured to fit into the respective slots 51, 53. Similarly, the second rotor segment interlocking feature 52, the first rotor segment interlocking feature 50, and the fastener 48 may cooperate with one another such that the first rotor segment 22 and the second rotor segments 24 are rigidly and permanently attached to each other.

Referring again to FIG. 5, the first rotor segment 22 attachment feature 40 is shown in greater detail. The attachment feature 40 may include holes 42, 43 formed in the first rotor segment 22. The attachment feature 40 may include an interlocking feature 50 formed in the first rotor segment 22. The interlocking feature 50 may include slots 51, 53 formed in the first rotor segment 22. The interlocking feature 50 may include tabs 59, 61. The second rotor segment 24 attachment feature 44 may include corresponding holes slots, and tabs that cooperate with the first rotor 22 attachment feature 40 holes 42, 43, slots 51, 53 and tabs 59, 61 such that the first rotor segment 22 and the second rotor segments 24 are rigidly and permanently attached to each other.

Referring again to FIGS. 2-4, the second rotor segment 24 attachment feature 44 interlocking features 52 may be disposed between the first rotor segment 22 interlocking features 50 when the first and second rotor segments 22, 24 are assembled. The hole 43 in the first rotor segment 22 may be coaxial with the hole 46 in the second rotor segment 24 when the first and second rotor segments 22, 24 are assembled. The fastener 48 may be disposed in at least the respective holes 43, 46 when the first and second rotor segments 22, 24 are assembled. The hole 42 in the first rotor segment 22 may be coaxial with the hole 47 in the second rotor segment 24 when the first and second rotor segments 22, 24 are assembled. The fastener 54 may be disposed in at least the respective holes 42, 47 when the first and second rotor segments 22, 24 are assembled.

The fastener 48, 54 may be a cylindrical pin, as shown in FIG. 2. Referring now to FIGS. 6A-F, in other embodiments, the fastener 48, 54 may be an open roll pin 58, a coiled roll pin 60, a knurled pin 62, a barbed pin 64, or any other suitable fastener. The fastener 48 may be riveted or swaged after installation. The fastener 48, 54 may include an interference fit enhancement feature 56. The interference fit enhancement feature 56 may include, but is not limited to, the spring force of the open roll pin 58, the spring force of the coiled roll pin 60, the knurls of the knurled pin 62, and the barbs of the barbed pin 64. The fastener 48, 54 may also include a fastener retention feature 66. The fastener retention feature 66 may include, but is not limited to, a cap or head 68 on one end of the fastener 48, a rivet or swage (not shown) on one or both ends of the fastener 48, 54 and a retaining clip 74 attached to a feature 72 in one or both ends of the fastener 48, 54.

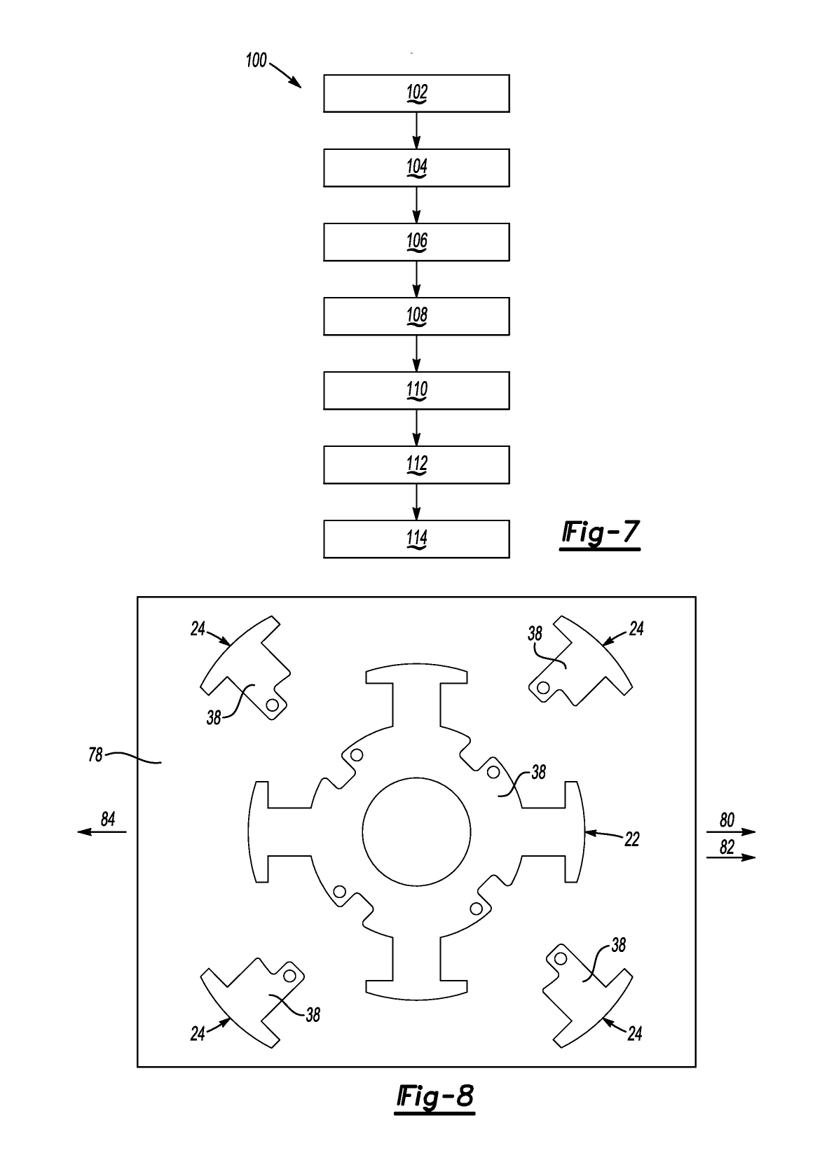

Referring now to FIG. 7, a method 100 to manufacture a multi-pole electric motor 14 includes forming 102 a first rotor segment 22, having a plurality of first poles 26, and a plurality of second rotor segments 24, each having a second pole 34, winding 110 a wire 28 onto the first poles 26 of the first rotor segment 22, winding 112 the wire 28 onto the second pole 34 of each of the second rotor segments 24, and attaching 114 the second rotor segments 24 rigidly to the first rotor segment 22 after winding 110, 112 the wire 28 on all of the poles 26, 34.

Winding 112 the wire 28 onto the second poles 34 of each of the second rotor segments 24 may include separating the second rotor segments 24 from the first rotor segment 22 such that winding the wire 28 on each second pole 34 does not include winding with a needle winder. Forming 102 the first rotor segment 22 may include spacing the first poles 26 sufficiently apart such that winding 110 the wire 28 on each first pole 26 of the first rotor segment 22 does not include winding with a needle winder. Winding 110, 112 may include winding with a needle winder having a needle that is configured to be sufficiently stiff to produce a uniform and orderly wind of the wire 38 and to be sufficiently durable to operate reliably.

Attaching 114 the second rotor segments 24 onto the first rotor segment 22 after winding 110, 112 the wire 28 on all of the poles 26, 34 may include pinning of the second rotor segments 24 to the first rotor segment 22. Attaching 114 the second rotor segments 24 onto the first rotor segment 22 after winding 110, 112 the wire 28 on all of the poles 26, 34 may include interlocking of a feature 52 on each of the second rotor segments 24 with a feature 50 on the first rotor segment 22.

The method 100 may include laminating 108 a plurality of sheets or layers 38 to form the first rotor segment 22 and the plurality of second rotor segments 24. Laminating 108 may include stacking the sheets or layers 38 and may include attaching the sheets or layers 38 via adhesive bonding, mechanical clinching, fastening, or any other suitable attachment method.

Referring now to FIG. 8, the sheets or layers 38 may be cut from a blank 78. The blank 78 is an uncut sheet of material that will subsequently be cut into the sheets or layers 38 for the first rotor segment 22 and the plurality of second rotor segments 24. The blank 78 may have a manufacturing direction 80 associated with its manufacturing process, such as a rolling, extruding, or machining direction. The blank 78 may have a first orientation 82, defined as parallel to and in the same direction as the manufacturing direction 80. The blank 78 may have a second orientation 84, defined as the opposite orientation from the first orientation 82. The blank 78 may have other orientations associated with the manufacturing direction 80. For example, the blank 78 may have an orientation that is rotated 90 degrees the manufacturing direction 80, an orientation that is rotated 270 degrees from the manufacturing direction, and other orientations that are rotated at other angles from the manufacturing direction 80.

Referring again to FIG. 7, the method 100 may include cutting 104 all of the sheets 38 for each respective layer of the first rotor segment 22 and the plurality of second rotor segments 24 from one blank 78. Cutting 104 may include die cutting, laser cutting, or any other suitable cutting method. The method 100 may include alternating 106 the orientation 82, 84 of the blank 78 for each subsequent layer of the first rotor segment 22 and the plurality of second rotor segments 24 such that the laminated sheets form a parallel stack. Alternating 106 the orientation is defined as reversing the orientation by 180 degrees.

The partially segmented rotor assembly 20, vehicle 10, and method 100 provided may also apply to a rotor for an electric generator for a vehicle.

While the best modes for carrying out the many aspects of the present teachings have been described in detail, those familiar with the art to which these teachings relate will recognize various alternative aspects for practicing the present teachings that are within the scope of the appended claims.

1. A partially segmented rotor assembly for an electric motor, comprising:
a first rotor segment having a plurality of first poles each wound with a wire and defining a first circumferential gap between the wire of each adjacent pair of the first poles; and
a plurality of second rotor segments, each having a second pole wound with the wire and rigidly attached to the first rotor segment in a respective one of the first circumferential gaps to form a plurality of second circumferential gaps between the wire of each first pole and the wire of the adjacent second poles;
wherein the first and second rotor segments are configured to cooperate with one another to minimize the second circumferential gaps.

2. The partially segmented rotor assembly of claim 1, wherein the first and second rotor segments are made of respective laminated sheets.

3. The partially segmented rotor assembly of claim 2, wherein the first rotor segment has an attachment feature including a hole formed in the first rotor segment and the second rotor segment has an attachment feature including a hole formed in the second rotor segment.

4. The partially segmented rotor assembly of claim 3, further comprising a fastener disposed in at least the respective holes formed in the attachment features of the first and second rotor segment such that the first and second rotor segment are rigidly attached to each other.

5. The partially segmented rotor assembly of claim 4, wherein the fastener, the hole formed in the attachment feature of the first rotor segment, and the hole formed in the attachment feature of the second rotor segment are configured such that the fastener is in an interference fit relationship with at least one of the holes formed in the attachment features of the first and second rotor segments.

6. The partially segmented rotor assembly of claim 5, wherein the second rotor segment attachment feature includes an interlocking feature and the first rotor segment attachment feature includes an interlocking feature; and wherein the second rotor segment interlocking feature and the first rotor segment interlocking feature cooperate with one another.

7. The partially segmented rotor assembly of claim 6, wherein the second rotor segment interlocking feature, the first rotor segment interlocking feature, and the fastener cooperate with one another.

8. The partially segmented rotor assembly of claim 7, wherein the fastener is a roll pin.

9. The partially segmented rotor assembly of claim 7, wherein the fastener includes an interference fit enhancement feature.

10. The partially segmented rotor assembly of claim 7, wherein the fastener includes a fastener retention feature.

11. A vehicle having an electric motor, comprising:
a partially segmented rotor assembly including:
a first rotor segment having a plurality of first poles wound with a wire and an attachment feature;
a plurality of second rotor segments, each having a second pole wound with the wire and an attachment feature; and
a fastener;
wherein the second rotor segment attachment feature, the first rotor segment attachment feature, and the fastener are configured to cooperate with one another such that the second rotor segment is rigidly attached to the first rotor segment.

12. The vehicle of claim 11, wherein the first rotor segment and the second rotor segments are made of respective laminated sheets; wherein the first rotor segment attachment feature includes a hole formed in the laminated sheets of the first rotor segment and the second rotor segment attachment feature includes a hole formed in the laminated sheets of the second rotor segment; wherein the fastener is disposed in at least the respective holes formed in the attachment features of the first rotor segment and the second rotor segment; and wherein the fastener, the hole formed in the attachment feature of the first rotor segment, and the hole formed in the attachment feature of the second rotor segment are configured such that the fastener is in an interference fit relationship with at least one of the holes formed in the attachment features of the first and second rotor segments.

13. The vehicle of claim 12, wherein the second rotor segment attachment feature includes an interlocking feature and the first rotor segment attachment feature includes an interlocking feature; and wherein the second rotor segment interlocking feature, the first rotor segment interlocking feature, and the fastener cooperate with one another.

14. A method to manufacture a rotor for an electric motor and having a plurality of poles, comprising:
forming a first rotor segment, having a plurality of first poles, and a plurality of second rotor segments, each having a second pole;
winding a wire onto the first poles of the first rotor segment;
winding the wire onto the second pole of each of the second rotor segments; and
attaching the second rotor segments rigidly to the first rotor segment after winding the wire on all of the poles.

15. The method of claim 14, wherein winding the wire onto the second pole of each of the second rotor segments includes separating the second rotor segments from the first rotor segment such that winding the wire on each second pole does not include winding with a needle winder.

16. The method of claim 15, wherein forming the first rotor segment includes spacing the first poles sufficiently apart such that winding the wire on each first pole of the first rotor segment does not include winding with a needle winder.

17. The method of claim 14, wherein attaching includes pinning of the second rotor segments to the first rotor segment.

18. The method of claim 17, wherein attaching includes interlocking of a feature on each of the second rotor segments with a feature on the first rotor segment.

19. The method of claim 15, further comprising:
laminating a plurality of sheets to form the first rotor segment and the plurality of second rotor segments; and
cutting all of the sheets for each respective layer of the first rotor segment and the plurality of second rotor segments from one blank.

20. The method of claim 19, further comprising alternating the orientation of the blank for each subsequent layer of the first rotor segment and the plurality of second rotor segments such that the laminated sheets form a parallel stack.
